(19) United States
(12) Patent Application Publication
(10) Pub. No.: US 2012/0134908 A1
(43) Pub. Date: May 31, 2012

(54) Method of Making Active Materials For Use in Secondary Electrochemical Cells

(76) Inventors: Titus Faulkner, Las Vegas, NV (US); Jon Parke, Milwaukee, WI (US)

(21) Appl. No.: 13/329,592

(22) Filed: Dec. 19, 2011

Related U.S. Application Data
(63) Continuation-in-part of application No. 12/752,652, filed on Apr. 1, 2010, now abandoned.
(60) Provisional application No. 61/169,995, filed on Apr. 16, 2009.

(51) Int. Cl. C01B 25/45

(52) U.S. Cl. 423/306

(57) ABSTRACT

The present invention provides for the preparation of an “optimized” lithium vanadium phosphate material. The materials are synthesized under conditions that avoid exposure to reducing gases, such as hydrogen, at high temperatures and thus materials of high performance are produced. The lithium vanadium phosphate materials so produced find use in producing electrodes for electrochemical cells.

This application is a continuation-in-part of U.S. Ser. No. 12/752,652, filed Apr. 1, 2010 which claims priority from U.S. Ser. No. 61/169,995, filed Apr. 16, 2009.

### FIELD OF THE INVENTION

The present invention relates to an advantageous process for the preparation of lithium vanadium phosphate materials which are electroactive and therefore find use in making electrodes for electrochemical cells. Such methods for making vanadium phosphate materials are advantageous in that the materials so produced have reduced cycle fading and exhibit a higher initial specific capacity compared to materials produced using known methods for making vanadium phosphate materials.

### BACKGROUND OF THE INVENTION

By way of example and generally speaking, lithium ion batteries are prepared from one or more lithium ion electrochemical cells containing electrochemically active (electroactive) materials. Such cells typically include, at least, a negative electrode, a positive electrode, and an electrolyte for facilitating movement of ionic charge carriers between the negative and positive electrode. As the cell is charged, lithium ions are transferred from the positive electrode to the electrolyte and, concurrently from the electrolyte to the negative electrode. During discharge, the lithium ions are transferred from the negative electrode to the electrolyte and, concurrently from the electrolyte back to the positive electrode. Thus with each charge/discharge cycle the lithium ions are transported between the electrodes. Such lithium ion batteries are called rechargeable lithium ion batteries or rocking chair batteries.

The electrodes of such batteries generally contain electrochemically active (electroactive) materials having a crystal lattice structure or framework from which ions, such as lithium ions, can be extracted and subsequently reinserted and/or from which ions such as lithium ions can be inserted or intercalated and subsequently extracted. Recently a class of transition metal phosphates and mixed metal phosphates have been developed, which have such a crystal lattice structure. These transition metal phosphates are insertion based compounds and allow great flexibility in the design of lithium ion batteries.

A class of such materials is disclosed in U.S. Pat. No. 6,528,033 B1 (Barker et al.). The compounds therein are of the general formula LiₐMI_{b}MII_{c} (PO₄)_{d} wherein MI and MII are the same or different. MI is a metal selected from the group consisting of Fe, Co, Ni, Mn, Cu, V, Sn, Cr and mixtures thereof. MII is optionally present, but when present is a metal selected from the group consisting of Mg, Ca, Zn, Sr, Pb, Cd, Sn, Ba, Be and mixtures thereof. More specific examples of such compounds include compounds wherein MI is vanadium and more specifically includes a material of the nominal general formula Li₃V₂(PO₄)₃. U.S. Pat. No. 6,645,452 B1 (Barker et al.) further discloses electroactive vanadium phosphates such as LiVPO₄F and LiV_{0.9}Al_{0.1}PO₄F.

Although these compounds find use as electrochemically active materials these materials are not always easily produced and it is not always straightforward on how to eliminate impurities and other possible defects. Thus, it would be beneficial to have a process for preparing such intercalation materials to produce an optimized material. The inventors of the present invention have now found a method for preparing such optimized vanadium phosphate materials.

### SUMMARY OF THE INVENTION

The present invention provides for the preparation of an “optimized” lithium vanadium phosphate material. The materials are synthesized under conditions that avoid exposure to reducing gases, such as hydrogen, at high temperatures and thus materials of high performance are produced. The lithium vanadium phosphate materials so produced find use in producing electrodes for electrochemical cells.

### BRIEF DESCRIPTION OF THE DRAWINGS

FIG. 1 shows a voltage curve which demonstrates that calcination under a hydrogen-containing atmosphere induces a change in the electrochemical behavior of LVP. More change occurs at higher temperatures and longer exposure to hydrogen.

FIG. 2 shows a cycling fade plot that demonstrates that calcinations for successively longer times at higher temperatures under a hydrogen-containing atmosphere produces a progressively worsening effect on the initial capacity and cycle fading of LVP.

### DETAILED DESCRIPTION OF THE INVENTION

Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

The following is a list of some of the definitions of various terms used herein:

As used herein “battery” refers to a device comprising one or more electrochemical cells for the production of electricity. Each electrochemical cell comprises an anode, a cathode and an electrolyte.

As used herein the terms “anode” and “cathode” refer to the electrodes at which oxidation and reduction occur, respectively, during battery discharge. During charging of the battery, the sites of oxidation and reduction are reversed.

As used herein the terms “nominal formula” or “nominal general formula” refer to the fact that the relative proportion of atomic species may vary slightly on the order of 1 percent to 5 percent, or more typically, 1 percent to 3 percent.

As used herein the words “preferred” and “preferably” refer to embodiments of the invention that afford certain benefits under certain circumstances. Further the recitation of one or more preferred embodiments are not intended to exclude other embodiments from the scope of the invention.

As used herein the term “optimized materials” refers to electroactive materials that possess improved performance properties, for example higher initial specific capacity or reduced cycle fading and the like, compared to electroactive materials produced in the presence of a reducing atmosphere, such as hydrogen.

Metal phosphates, and mixed metal phosphates and in particular lithiated metal and mixed metal phosphates have recently been introduced as electrode active materials for ion batteries and in particular lithium ion batteries. These metal phosphates and mixed metal phosphates are insertion based compounds. What is meant by insertion is that such materials have a crystal lattice structure or framework from which ions, and in particular lithium ions, can be extracted and subsequently reinserted and/or permit ions to be inserted and subsequently extracted.

The transition metal phosphates allow for great flexibility in the design of batteries, especially lithium ion batteries. Simply by changing the identity of the transition metal allows for regulation of voltage and specific capacity of the active materials. Examples of such transition metal phosphate cathode materials include such compounds of the nominal general formulae LiFePO₄, Li₃V₂(PO₄)₃ and LiFe₁₋ₓMgₓPO₄ as disclosed in U.S. Pat. No. 6,528,033 B1 (Barker et al, hereinafter referred to as the '033 patent) issued Mar. 4, 2003.

A class of compounds having the nominal general formula Li₃V₂(PO₄)₃ (lithium vanadium phosphate or LVP) are disclosed in U.S. Pat. No. 6,528,033 B1. It is disclosed therein that LVP can be prepared by ball milling V₂O₅, Li₂CO₃, (NH₄)₂HPO₄ and carbon, and then pelletizing the resulting powder. The pellet is then heated to 300° C. to remove the NH₃. The pellet is then powderized and repelletized. The new pellet is then heated at 850° C. for 8 hours to produce the desired electrochemically active product.

Monoclinic lithium vanadium phosphate, Li₃V₂(PO₄)₃ or LVP is commonly synthesized at temperatures of 700° C. and above. At these temperatures, this material is susceptible to damage from a few percent hydrogen in the synthesis atmosphere. The hydrogen may be added to the atmosphere intentionally or it may be a by-product from the precursors of the synthesis reaction. The presence of hydrogen in the synthesis atmosphere reduces initial specific capacity and increases cycle fading in materials produced in such atmosphere. It would therefore be beneficial to synthesize LVP under a hydrogen free atmosphere.

To prevent hydrogen damage it is necessary to remove all sources of hydrogen before the precursor reaches 700° C. Water and organic vapor are likely by-products of the LVP formation reaction and both are potential sources of hydrogen, especially in the presence of residual carbon. To prevent potential damage from hydrogen during the synthesis, the following techniques may be useful. 1) A wait step in the heating ramp profile can be employed to allow by-products to evolve at a temperature below 700° C.; for instance stopping the heating ramp at a temperature of 350° C. and holding at that temperature for about one to about two hours (dwell time). The wait step is employed at from about 300° C. to about 650° C. 2) Modified furnace loading conditions such as powder beds shallower than about 4 cm depth and more preferably shallower than about 2 cm depth will prevent the entrapment of gaseous by-products in the powder beds. Alternatively, the precursors can be heated in a furnace wherein the precursors are fed into the powder bed of the furnace at a feed rate wherein the depth of the precursor is less than about 4 cm. 3) A rapid gas purge rate can accelerate the removal of hydrogen and hydrogen containing by-products to less than 0.1% by volume of the exhaust gas before high temperatures (about 700° C.) are reached.

U.S. Pat. No. 6,739,281, issued May 4, 2004 discloses a method for preparing lithium metal phosphates using a solid state reaction. Solid state reactants include at least one inorganic metal compound and a source of reducing carbon. Reducing carbon may be supplied by elemental carbon, by an organic material, or by mixtures thereof. The organic material is one that can form decomposition products containing carbon in a form capable of acting as a reductant. In a preferred embodiment, the solid state reactants also include an alkali metal compound.

In Example 16 of U.S. Pat. No. 6,730,281 trilithium vanadium (III) phosphate is produced from vanadium (V) oxide. The overall reaction scheme is:

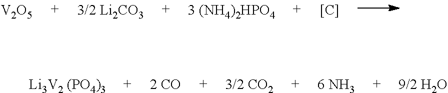

(a) The reactants above are ball milled using ball mill with suitable media.
(b) The powder mixture is then pelletized.
(c) The pellet is heated in an inert atmosphere at 2°/minute to 300° C. to remove CO₂ (from Li₂CO₃) and to remove NH₃ and H₂O and then cooled to room temperature.
(d) The resulting material is then powderized and repelletized.
(e) The pellet is heated in inert atmosphere at a rate of 2° C./minute to 850° C. and held for 8 hours at 850° C.
(f) The pellet is cooled to room temperature at a rate of 2°/minute in argon and then powderized.

In one embodiment of the present invention the dwell time of the first heating step of the synthesis outlined above can be increased to allow most of the by-products to evolve at the lower temperature. In alternate embodiments furnace conditions can be modified by using a more rapid gas purge rate or shallower powder beds.

A class of compounds having the nominal general formula Li₃V₂(PO₄)₃ (lithium vanadium phosphate or LVP) are disclosed in U.S. Pat. No. 6,528,033 B1 issued Mar. 4, 2003. It is disclosed therein that LVP can be prepared by ball milling V₂O₅, Li₂CO₃, (NH₄)₂HPO₄ and carbon, and then pelletizing the resulting powder. The pellet is then heated to 300° C. to remove the NH₃. The pellet is then powderized and repelletized. The new pellet is then heated at 850° C. for 8 hours to produce the desired electrochemically active product.

In another embodiment of the present invention the dwell time of the first heating step of the synthesis outlined above can be increased to allow most of the by-products to evolve at the lower temperature. In alternate embodiments furnace conditions can be modified by using a more rapid gas purge rate or shallower powder beds.

U.S. Ser. No. 11/850,792 discloses a method that the hydrothermal pretreatment of a mixture of precursor materials (including a vanadium oxide, a source of lithium ion and a source of phosphate ion) via high pressure at relatively low temperatures and then calcining (heating) the hydrothermally treated precursors at relatively high temperatures for a time sufficient to produce lithium vanadium phosphate.

In another embodiment of the present invention the calcining step can be carried out in two steps (an initial lower temperature and then at the higher temperature) to allow most of the by-products to evolve at the lower temperature. In alternate embodiments furnace conditions can be modified by using a more rapid gas purge rate or shallower powder beds.

U.S. Ser. No. 11/682,339, filed Mar. 6, 2007 discloses the preparation of vanadium phosphate precursors which are then reacted with an appropriate alkali metal according to, for example the following reactions:

Li₃PO₄+2VPO₄→Li₃V₂(PO₄)₃

or

VPO₄+LiF→LiVPO₄F

or

3NaF+2VPO₄→Na₃V₂(PO₄)₂F₃.

It is disclosed in U.S. Ser. No. 11/682,339 that typically the VPO₄ precursor, alkali metal containing compound and optional other metal containing compound are milled and then pelletized. The mixture is then heated at a temperature from about 500° C. to about 900° C. More preferably the mixture is heated from about 500° C. to about 800° C. and most preferably from about 600° C. to about 750° C. The mixture is heated for about 30 minutes to about 16 hours and more preferably from about 1 to about 8 hours.

In another embodiment of the present invention the heating step can be carried out in two steps (an initial lower temperature and then at the higher temperature) to allow most of the by-products to evolve at the lower temperature. In alternate embodiments furnace conditions can be modified by using a more rapid gas purge rate or shallower powder beds.

U.S. Ser. No. 11/953,953 discloses a method for preparing a lithium vanadium phosphate material comprising mixing water, lithium dihydrogen phosphate, V₂O₃ and a source of carbon to produce a first slurry; wet blending the first slurry; spray drying the wet blended slurry to form a precursor composition; milling the precursor composition to obtain a milled precursor composition; compacting the milled precursor to obtain a compacted precursor; pre-baking the compacted precursor composition to obtain a precursor composition with low moisture content; and calcining the precursor composition with low moisture content at a time and temperature sufficient to produce a lithium vanadium phosphate. The lithium vanadium phosphate so produced can optionally be further milled to obtain the desired particle size.

In another embodiment of the present invention the pre-baking step outlined above can be carried out for a longer dwell time to allow most of the by-products to evolve at the lower temperature. In alternate embodiments furnace conditions can be modified by using a more rapid gas purge rate or shallower powder beds.

Specific benefits and embodiments of the present invention are described above. It should be understood, however, that the detailed description and specific examples, while indicating embodiments among those preferred, are intended for purposes of illustration only and are not intended to limit the scope of the invention. Other processes known for producing lithium vanadium phosphate material would also benefit from the conditions described above, reducing exposure of the lithium vanadium phosphate materials to the effects of a reducing atmosphere, such as hydrogen, at high temperatures.

The lithium vanadium phosphate materials produced by the above described methods are usable as an electrode active material, for lithium ion (Li⁺) removal and insertion. These electrodes are combined with a suitable counter electrode to form a cell using conventional technology known to those with skill in the art. Upon extraction of the lithium ions from the lithium metal phosphates or lithium mixed metal phosphates, significant capacity is achieved.

The lithium vanadium phosphates of the present invention are useful in forming an electrochemical cell or battery containing:
(a) a first electrode (also commonly referred to as a positive electrode or cathode) which includes an active material of the present invention;
(b) a second electrode (also commonly referred to as a negative electrode or anode) which is a counter-electrode to the first electrode; and
(c) an electrolyte in ion-transfer communication with the first and second electrodes.

The architecture of a battery is not limited to any particular architecture, and may be selected from the group consisting of cylindrical wound designs, z-fold designs, wound prismatic and flat-plate prismatic designs, and polymer laminate designs.

The following non-limiting examples illustrate the compositions and methods of the present invention.

### Example 1

LVP was prepared by mixing of LVP precursors in a water based slurry, evaporating the water at 350° C. followed by calcining under pure argon at 875° C. for eight hours.

### Example 2

LVP was prepared using the material prepared as in Example 1 followed by calcination a second time under an atmosphere of 3% hydrogen in 97% argon at 700° C. for two hours.

### Example 3

LVP was prepared using the material prepared as in Example 1 followed by calcination a second time under an atmosphere of 3% hydrogen in 97% argon at 800° C. for two hours.

### Example 4

LVP was prepared using the material prepared as in Example 1 followed by calcination a second time under an atmosphere of 3% hydrogen in 97% argon at 900° C. for four hours.

### Example 5

LVP was prepared using the material prepared as in Example 1 followed by calcination a second time under an atmosphere of 3% hydrogen in 97% argon at 925° C. for sixteen hours.

The LVP materials of Examples 1-5 were tested in a rocking-chair battery configuration contained in a flexible pouch. Cathodes were formulated from 95% LVP by weight; 1% added Super-P carbon; and 4% PVDF dissolved and suspended in n-methylpyrrolidinone. The LVP contained 6% residual carbon by weight. This mixture was blended using high shear and cast into a thin film on an aluminum current collector using a doctor blade.

Anodes composed of graphitic carbons and PVDF coated on a copper current collector were prepared with capacity per unit area to match the cathode. A stack consisting of anode, separator and cathode was wetted with electrolyte composed of lithium hexafluorophosphate in a mixture of EC, DEC and EMC. The stack was then sealed in a pouch formed from aluminum laminated packaging material.

The cells thus prepared were cycled gavanostatically at 23° C. at a c/2 charge and discharge rate.

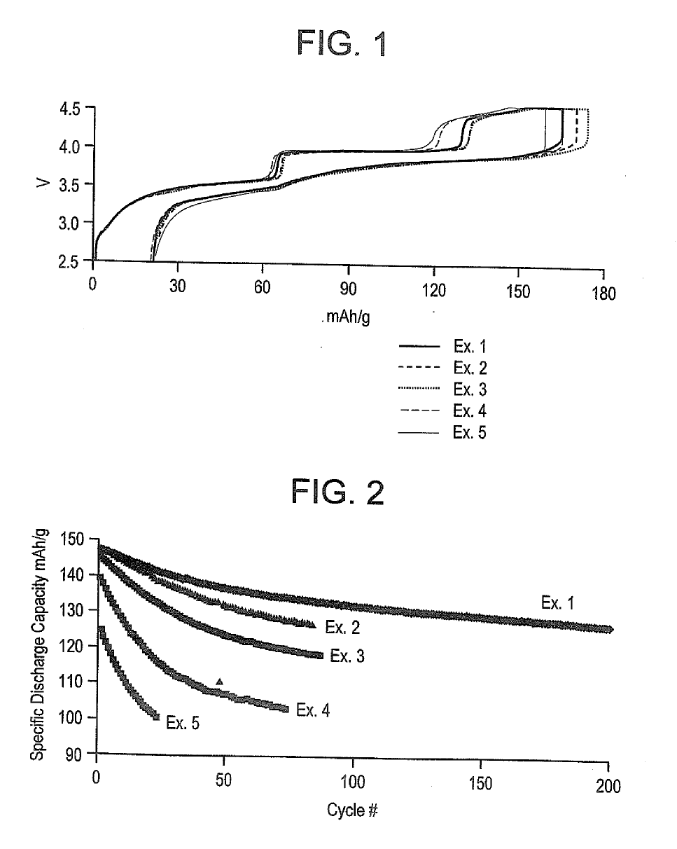

The voltage curve in FIG. 1 demonstrates that calcination under a hydrogen-containing atmosphere induces a change in the electrochemical behavior of the LVP, with more change occurring for higher temperatures and longer times of exposure to hydrogen.

The cycling fad plot in FIG. 2 demonstrates that calcinations for successively longer times and higher temperatures under a hydrogen containing atmosphere produces a progressively worsening effect on the initial capacity and cycling fade of LVP. The cycling fade plot demonstrates that methods for synthesis of LVP that call for temperatures above 700° C. and use substantially hydrogen free atmospheres will produce higher initial capacity and less fade than methods that use the above 700° C. temperature range but have hydrogen present in the synthesis atmosphere.

The preferred methods of LVP synthesis using temperatures above 700° C. are carbothermal or non-reduction methods in which the atmosphere is substantially free of hydrogen or other gases that produce hydrogen, such as water vapor in the presence of carbon.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A method for preparing lithium vanadium phosphate comprising mixing starting materials to form lithium-, vanadium-, phosphate containing precursor and heating the precursor in an inert atmosphere at a temperature and for a time sufficient to form lithium vanadium phosphate the improvement comprising removing all sources of hydrogen from the atmosphere and the precursor before the precursor is heated to 700° C.

2. The method according to claim 1 comprising using a heat profile wherein a wait step is used in the heating ramp profile from about one to about two hours to allow by-products of the precursor to evolve before the precursor is heated to 700° C.

3. The method according to claim 2 wherein the wait step is employed at about 300° C. to about 650° C.

4. The method according to claim 1 comprising heating the precursor in a furnace employing a shallow powder bed in the furnace wherein the depth of the powder bed is less than about 4 cm.

5. The method according to claim 1 comprising heating the precursor in a furnace and feeding the precursor into a powder bed of the furnace at a feed rate wherein the depth of the precursor is less than about 4 cm.

6. The method according to claim 1 comprising using a gas purge rate sufficient to dilute the total amount of hydrogen and hydrogen-containing species to less than 0.1% by volume of the exhaust gas before the precursor is heated to 700° C.

7. A method for preparing lithium vanadium phosphate comprising ball milling V₂O₅, Li₂CO₃, (NH₄)₂HPO₄ and optionally carbon to form a precursor; first heating the precursor in an inert atmosphere at 2° C./minute to 300° C.; and then heating in a second step in an inert atmosphere at a rate of 2° C./minute to 850° C. for 8 hours the improvement comprising removing all sources of hydrogen from the atmosphere and precursor before the precursor is heated to 700° C.

8. The method according to claim 7 comprising using a heat ramp profile in the second heating step wherein a wait step of from about one to about two hours is used to allow by-products of the precursor to evolve before the precursor is heated to 700° C.

9. The method according to claim 8 wherein the wait step is employed at about 300° C. to about 650° C.

10. The method according to claim 7 comprising heating the powder in the second heating step in a furnace employing a shallow furnace bed wherein the depth of the powder bed is less than about 4 cm.

11. The method according to claim 7 comprising heating the precursor in the second step in a furnace and feeding the precursor into a powder bed of the furnace at a feed rate wherein the depth of the precursor is less than about 4 cm.

12. The method according to claim 7 comprising using a gas purge rate sufficient to dilute the total amount of hydrogen and hydrogen-containing species to less than 0.1% by volume of the exhaust gas before the precursor is heated to 700° C.

13. A method for preparing a lithium vanadium phosphate comprising hydrothermally pretreating a mixture of precursor materials comprising a vanadium oxide, a source of lithium ion and a source of phosphate ion via high pressure at relatively low temperatures and then calcining the hydrothermally treated precursors at relatively high temperatures for a time sufficient to produce lithium vanadium phosphate the improvement comprising removing all sources of hydrogen from the atmosphere and precursor before the precursor is heated to 700° C.

14. The method according to claim 13 comprising using a heat ramp profile in the calcining step wherein a wait step from about one to about two hours is used.

15. The method according to claim 14 wherein the wait step is employed at about 300° C. to about 650° C.

16. The method according to claim 13 comprising calcining the hydrothermally treated precursors in a furnace in a shallow powder bed wherein the depth of the powder bed is less than about 4 cm.

17. The method according to claim 13 comprising using a gas purge rate sufficient to dilute the total amount of hydrogen and hydrogen-containing species to less than 0.1% by volume of the exhaust gas before the precursor is heated to 700° C.

18. A method for preparing a lithium vanadium phosphate comprising milling a VPO₄ precursor, an alkali metal containing compound and optionally another metal containing compound to form a precursor and then heating the precursor the improvement comprising removing all sources of hydrogen from the atmosphere and precursor before the precursor is heated to 700° C.

19. The method according to claim 18 comprising heating using a heat ramp profile employing a wait step from about one to about two hours to allow by-products to evolve before the precursor is heated to 700° C.

20. The method according to claim 19 wherein the wait step is employed at about 300° C. to about 650° C.

21. The method according to claim 18 comprising heating the precursor in a furnace in a shallow powder bed wherein the depth of the powder bed is less than about 4 cm.

22. The method according to claim 18 comprising heating the precursor in a furnace and feeding the precursor material into the powder bed of the furnace at a feed rate wherein the depth of the precursor is less than about 4 cm.

23. A method according to claim 18 comprising using a gas purge rate sufficient to dilute the total amount of hydrogen and hydrogen-containing species to less than 0.1% by volume of the exhaust gas before the precursor is heated to 700° C.

24. A method for preparing a lithium vanadium phosphate material comprising mixing water, lithium dihydrogen phosphate, V₂O₃ and a source of carbon to produce a first slurry; wet blending the first slurry; spray drying the wet blended slurry to form a precursor composition; milling the precursor composition to obtain a milled precursor composition; compacting the milled precursor to obtain a compacted precursor; pre-baking the compacted precursor composition to obtain a precursor composition with low moisture content; and calcining the precursor composition with low moisture content at a time and temperature sufficient to produce a lithium vanadium phosphate the improvement comprising removing all sources of hydrogen from the atmosphere before the precursor is heated to 700° C.

25. The method according to claim 24 comprising using a heat ramp profile in the calcining step wherein a wait step is employed from about one to about two hours to allow by-products to evolve before the precursor is heated to 700° C.

26. The method according to claim 25 wherein the wait step is employed at about 300° C. to about 650° C.

27. The method according to claim 24 comprising calcining the precursor composition in a furnace in a shallow powder bed wherein the depth of the powder bed is less than about 4 cm.

28. The method according to claim 17 comprising using a gas purge rate sufficient to dilute the total amount of hydrogen and hydrogen-containing species to less than 0.1% by volume of the exhaust gas before the precursor is heated to 700° C.
